(19) United States
(12) Patent Application Publication
(10) Pub. No.: US 2004/0119762 A1
(43) Pub. Date: Jun. 24, 2004

(54) Systems and methods for freeform pasting

(75) Inventors: Laurent Denoue, Palo Alto, CA (US); Patrick Chiu, Menlo Park, CA (US); Tohru Fuse, Santa Clara, CA (US); Lester D. Nelson, Santa Clara, CA (US); Elizabeth F. Churchill, San Francisco, CA (US)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/326,965

(22) Filed: Dec. 24, 2002

(51) Int. Cl. G09G 5/00

(52) U.S. Cl. 345/863

(57) ABSTRACT

A method of freeform pasting comprises: selecting at least one displayed content indicated by a user input; determining a location specified by a freeform user input; and pasting the selected content at the specified location in accordance with the freeform user input. In various embodiments, selecting at least one displayed content may comprise identifying the at least one displayed content intersected by a freeform line, at least partially enclosed by a freeform line that forms a substantially closed shape, and/or at least partially disposed between a pair of freeform lines. A method of freeform pasting comprises: selecting at least one displayed content indicated by a freeform user input; identifying the selected content based on the freeform user input; selecting the identified content; determining a location specified by a user; and pasting the selected identified content at the specified location.

### BACKGROUND OF THE INVENTION

1. Field of Invention

This invention is directed to systems and methods for freeform pasting.

2. Description of Related Art

As low-cost, digital note-taking devices become more pervasive and ubiquitous, system and methods for taking and sharing notes have been developed. Shared note taking enables groups to better communicate ideas and information. Various collaborative note-taking systems have been devised that capture, store and share notes and ideas generated by participants using appropriate communication devices and network. Such systems provide group access to personal notes, presentation slides, and any other documents or sources of information relative to a particular meeting or session. This sharing and exchanging of ideas and information enhance the efficiency and the capability of individuals and groups.

Current note-taking systems, such as described by Davis et al. in “NotePals: Lightweight Note Sharing by the Group, for the Group”, In Proceedings of Human Factors in Computer Systems: CHI 99, provide meeting support systems that automatically combine individual meeting notes into a shared record. In the NotePals system, group members record notes on portable pen-based devices, such as Personal Digital Assistants. NotePals combines the individual notes into a shared document. However, NotePals only provides access to the notes and information after the conclusion of the event during which the notes were generated.

Another important element of collaborative note taking involves text entry, prediction, and recommendation. Several techniques exist to allow fast text entry of words and notes using a stylus. Some techniques provide text completion capabilities that automatically present a list of one or more words or phrases that complete an entry begun by a user for, for example, insertion into notes. These words or phrases are often extracted from a dictionary, such as the Ipaq soft keyboard completion. Another system, the Reactive Keyboard, predicts words by analyzing words previously used by a user and presents note insertion options. Other systems, such as POBox, present words predicted using different sources, including a dictionary, the frequency of use, and their correlation (e.g., “interface” comes after “user in “user interface”).

Another aspect of collaborative note taking systems is the use of filtering systems that allow information to be coordinated and shared. A collaborative filtering system can leverage the information of all group members by reading and/or browsing the words, preferences, and interactions of each group member and/or other sources of information. Collaborative filtering algorithms are used by several systems, like Tapestry, GroupLens, PHOAKs, and Fab, to recommend documents and news messages based, for example, on users' preferences.

Pasting, that is, accessing information at one location and placing the accessed information in another location, is generally well known. For example, most word processing software includes that capability of, for example, copying and/or cutting text and pasting the text in another location.

Environments other than collaborative note taking systems are known in which information may be pasted. For example, information or digital content may be displayed and manipulated using an electronic whiteboard system as described by Moran et al. in “Pen-Based Interaction Techniques For Organizing Material on an Electronic Whiteboard”, Proceedings of the UIST'97, Symposium on User Interface Software and Technology.

### SUMMARY OF THE INVENTION

This invention expands the concept of pasting to freeform pasting. The systems and methods according to this invention are applicable to any known or hereafter developed display environment. Thus, it is to be understood that manipulation of information or digital content on large screen displays, including projection, mimio, touchscreen, interactive and plasma displays, or in composite documents, including scrapbooks, Web logs and Web pages, may be accomplished by the systems and methods according to this invention.

In various exemplary embodiments, freeform pasting according to this invention is useful with interactive freeform displays of data, such as collaborative note taking systems and touch sensitive public information displays, for sharing or reusing information that has already been selected by a user or other users. For example, the systems and methods according to this invention may be incorporated into collaborative note taking systems and methods such as those disclosed in copending U.S. patent application Ser. No. 10/125,346, filed Apr. 19, 2002, which is incorporated herein by reference in its entirety.

This invention provides systems and methods for performing a copy and paste operation for information using a freeform user input.

This invention separately provides systems and methods for simplified capturing and pasting of digital content.

This invention separately provides systems and methods for performing a copy and paste operation with greater flexibility.

This invention separately provides systems and methods for performing a copy and paste operation of ink-based information.

This invention separately provides systems and methods that allow a user to specify where and/or how selected information is pasted.

This invention separately provides systems and methods for shared pasting.

This invention separately provides systems and methods that help a user select information.

This invention separately provides systems and methods that recognize the structure of the information to be pasted.

This invention separately provides systems and methods that segment information to be pasted.

This invention separately provides systems and methods that automatically segment information to be pasted based on a previous user selection.

In various exemplary embodiments of the systems and methods according to this invention, digital content may include, but is not limited to freeform ink, text and graphics.

In various exemplary embodiments of the systems and methods according to this invention, at least one displayed content is selected as indicated by a user input. A location specified by a freeform user input is determined and the selected content is pasted at the specified location in accordance with the freeform user input.

In various exemplary embodiments, selecting at least one displayed content comprises identifying the at least one displayed content intersected by a freeform line. In various exemplary embodiments, selecting at least one displayed content comprises identifying the at least one displayed content at least partially enclosed by a freeform line that forms a substantially closed shape. In various exemplary embodiments, selecting at least one displayed content comprises identifying at least one displayed content at least partially disposed between a pair of freeform strokes or lines. In various exemplary embodiments, selecting at least one displayed content comprises selecting at least one freeform ink.

In various exemplary embodiments, determining a location comprises identifying a freeform line. In other various exemplary embodiments, determining a location comprises identifying a user touch, tap or click.

In various exemplary embodiments, pasting the selected content at the specified location in accordance with the freeform user input comprises transforming the selected content. In various exemplary embodiments, transforming the selected content comprises wrapping the selected content around a freeform line corresponding to the freeform user input and/or fitting the selected content into an area defined by a freeform line corresponding to the freeform user input. In other exemplary embodiments, pasting the selected content at the specified location in accordance with the freeform user input comprises transforming existing content.

In various exemplary embodiments of the systems and methods according to this invention, at least one displayed content indicated by a freeform user input is selected. The selected content is identified based on the freeform user input. The identified content is selected and a location specified by a user is determined. The selected identified content is pasted at the specified location.

In various exemplary embodiments, identifying the selected content based on the freeform user input comprises storing the selected content. In various exemplary embodiments, identifying the selected content based on the freeform user input further comprises storing segmentation information for the selected content. In various exemplary embodiments, identifying the selected content based on the freeform user input comprises providing visual feedback to a user. In various exemplary embodiments, providing visual feedback to a user comprises applying a visual modification to the selected content.

In various exemplary embodiments of the systems and methods according to this invention, shared words and/or text can be displayed on devices used by users to communicate with a collaborative note taking system. Shared notes can be displayed using differing text variations and/or graphics to assign value or meaning to the shared note.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the invention will be described in detail with reference to the following figures.

FIG. 1 is a block diagram of an exemplary embodiment of a collaborative data system and network usable with the systems and methods of this invention.

FIGS. 2-5 illustrate a first exemplary embodiment according to this invention.

FIGS. 6-8 illustrate a second exemplary embodiment according to this invention.

FIGS. 9-10 illustrate a third exemplary embodiment according to this invention.

FIGS. 11-12 illustrate a fourth exemplary embodiment according to this invention.

FIG. 13 is a flowchart outlining an exemplary embodiment of a method for freeform pasting according to this invention.

FIG. 14 is a flowchart outlining an exemplary embodiment of a method for freeform pasting according to this invention.

### DETAILED DESCRIPTION OF EXEMPLARY EMBODIMENTS

As disclosed by the incorporated '346 application, a user of a real-time collaborative note taking system can insert information from other users and sources through simple insertion techniques. For example, text may be selected using a single-tap of a stylus and then pasted at a desired location. Such a technique may also be used for freeform ink. However, such a technique does not allow a user to specify how the freeform ink is pasted. Various embodiments according to this invention allow a user to specify where and how selected information is pasted.

In various exemplary embodiments according to this invention, a user may identify or select information using a freeform input. For example, a user may generate one or more lines that identify the information. In various exemplary embodiments, the one or more lines may intersect, enclose or otherwise delineate the information to be selected.

Similarly, in various exemplary embodiments according to this invention, a user may specify how and/or where the selected information is to be pasted using a freeform input. Alternatively, a user may specify where the selected information is to be pasted by one or more touches on a screen or display.

In various exemplary embodiments according to this invention, a user may indicate a structure when selecting information. For example, a user may segment information using separate freeform strokes. A subsequent user may then select the information without specifying any segmentation and the system may automatically segment the information based on the previous user input.

Further, in various exemplary embodiments, user selections may be stored and may be identified to other users. This may provide users with an awareness of another user's interests. Also, this may allow a subsequent user to select previously selected information in a simplified manner, such as, for example, using a simple mouse click or stylus tap rather then a freeform stroke.

The systems and methods according to this invention may be implemented using any combination of known or later-developed hardware devices and/or software programs designed to provide a level of compatible communication and exchange of data/information in accordance with the disclosed invention. The pasting systems and methods according to this invention may also be used in any other known or later-developed multi-user interaction, such as instant messaging sessions with user devices such as a cell phone or a personal digital assistant (PDA).

It should be appreciated that the types of communication devices, distributed networks, and collaborative note taking or other multi-user interaction systems used to transmit, receive and display shared information may vary or differ depending on the types of systems and/or devices being used. The systems and methods of this invention do not depend on any specific collaborative note taking or other multi-user interaction system and/or any specific distributed network. Accordingly, the systems and methods are usable with any appropriate system and/or any distributed network.

For ease of understanding, the following detailed description of the exemplary embodiments of the systems and methods of this invention are directed primarily to a specific type of multi-user interaction system, that is, a collaborative note taking system. However, it should be appreciated that the systems and methods of this invention are not limited to collaborative note-taking systems. Thus, in the following detailed description, it should be understood that description is equally applicable to any appropriate known or later-developed multi-user interaction system. Further, the systems and methods of this invention may be embodied in any known or later-developed single-user system.

Furthermore, while the following detailed description of the exemplary embodiments of the systems and methods of this invention are directed primarily to pasting freeform ink, it should be understood that the is equally applicable to pasting other information or digital content such as text and graphics.

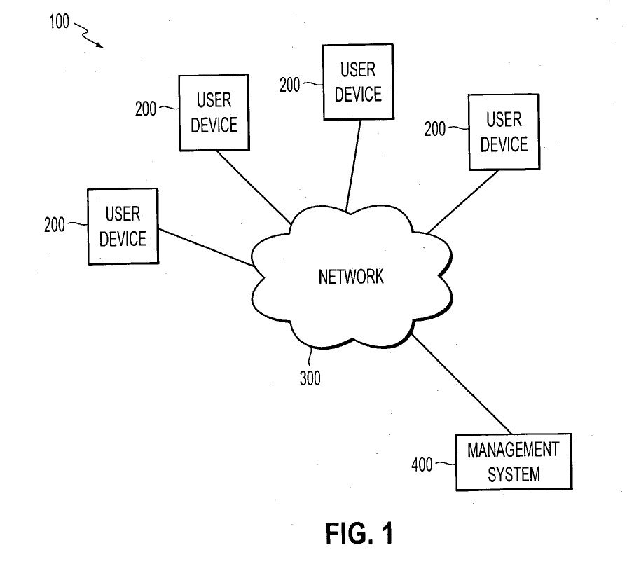

FIG. 1 is a block diagram of an exemplary embodiment of a collaborative data sharing system 100 usable to connect a user with other users. As shown in FIG. 1, the collaborative data sharing system 100 includes one or more user devices 200 connected to a network 300. A collaborative data management system 400 is also connected to the network 300. The collaborative data sharing system 100 may be used to share various information, such as image data, numerical data, graphical data, gestural data, sounds, speech and other audio data, multimedia data and any other known or later developed types of data.

It should be appreciated that the user devices 200, the distributed network 300 and the collaborative data management system 400, as shown in FIG. 1, while depicted separately, are not necessarily separate and distinct components. Thus, the functions and/or operations of each of these elements may be carried out by one or more devices, structures, and/or systems. Further, it should be appreciated that the user devices 200 in FIG. 1 may be any devices that use a distributed network to achieve connectivity with another device.

The user devices 200 can be any devices that are connectable to a data communication network. Each user device 200 may be implemented using a programmed general computer, a special purpose computer, a programmed microprocessor, a digital signal processor (DSP), and ASIC or other integrated circuit device or programmable logic device such as a PLD, PLA, FPGA or PAL, or the like, or using physically distinct hardware circuits, such as discrete logic elements or discrete circuit elements. In general, any hardware and/or software system capable of implementing and processing data and information from a data network may be used to implement each of the user devices 200. Alternatively, the user device 200 can be implemented as a portion of a software program usable to form the overall control system of a computing device, such as software routines, objects and/or application programming interfaces or the like. In general, the user device 200 can be implemented using a personal computer, a laptop or other portable computer, a personal digital assistant, a hand-held computer, a cell phone, a text-capable pager, or the like.

The network 300 can be implemented using any one or more of public switched telephone networks, local area networks, wide area networks, storage area networks, intranets, extranets, the Internet, or any other type of distributing network, each of which can include wired and/or wireless portions.

The collaborative data management system 400 includes, but is not limited to, any known or later developed software system that defines, executes, filters, and/or controls collaborative data processes. Further, the collaborative data management system 400 may control the interactions between users and the interaction of users with each other and applications. Also, the collaborative data management system 400 may provide administrative and/or supervisory functions. It should be appreciated that the type of collaborative data management system 400 that is implemented can depend upon the requirements of the collaborative session being managed and the level of requirements to be controlled.

In various exemplary embodiments, a user of the collaborative data sharing system 100 uses the user device 200 to take notes and/or to input information relative to the collaborative session. In various exemplary embodiments, at the start of the collaborative session, the user employs the user device 200 to log into a particular collaborative note taking session. The user device 200 accesses the collaborative data management system 400 via the network 300 using a compatible communication process. For example, if the collaborative data management system 400 is located on an Internet Web server, the user can access the collaborative data management system 400 via the Internet using an HTTP connection.

Various other details of the exemplary collaborative data sharing system 100 are discussed in the incorporated '346 application. Each user device 200 may include one or more input devices and one or more display devices. The input devices include, but are not limited to, a keyboard, a keypad, a mouse, a track ball, a track pad, a touch screen with or without an associated stylus, a joy stick, a pen-base system, or any other known or later-developed system for providing control and/or data signals to the user device 200. The input devices may further include any manual or automated device usable by a user or other system to present data or other stimuli to the user device 200. For example, the input device 252 can be any known or later developed technology suitable for note taking, such as a remote laptop computer, pen-based notebook computer, or personal digital assistant. Thus, it should be understood that any known or later developed device that is capable of carrying out various steps and/or functions of the methods and systems according to this invention may be used.

In operation, the user device 200 is used to input various information and to interact with displayed information as desired by the user of the user device 200 and to provide the information to the collaborative data management system 400. The user device 200 is further used to receive information from the collaborative data management system 400, to display text or other digital content corresponding to the received information, to select one or more of the displayed text or digital content, and relocate the selected one or more displayed text or digital content according to input by the user of that user device 200. Information is transmitted via the network 300 to the user devices 200 and displayed on the user devices 200 for insertion into the other user's annotated notes.

Users may opt to select one or more of the displayed text or digital content. According to a first exemplary embodiment of the systems and methods of this invention, the selection technique uses a freeform user input to identify the displayed text or digital content that is to be selected.

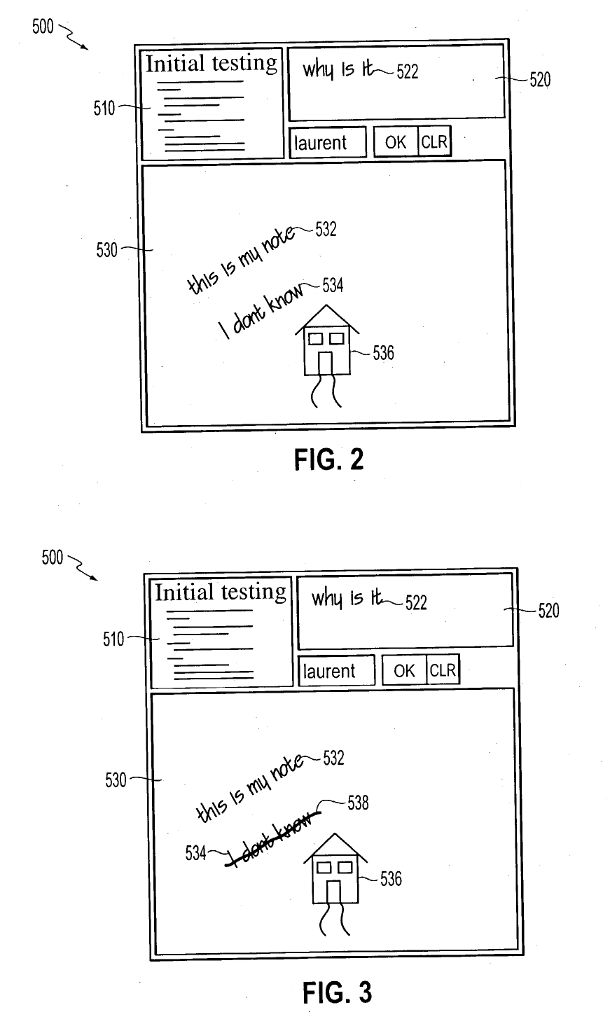

As shown in FIGS. 2-5, a user may select displayed text or digital content to be pasted. FIG. 2 illustrates an original state of an exemplary display 500. The display 500 includes three areas: a slide display 510 showing a slide image of a current slide; a user note display 520 showing one or more notes 522 of the user of the particular device; and a shared note display 530 showing shared digital content, such as multiple freeform inks 532, 534 and 536.

The user of the device may select information from the shared digital content displayed by the shared note display 530 using a freeform stroke or gesture. For example, as shown in FIG. 2, the user may generate a line 538 that intersects the information or digital content to indicate that the information or digital content is to be selected. In various exemplary embodiments, the line 538 not only indicates that the portions of the information or digital content that are intersected should be selected, but may also indicate that portions of the information or digital content that are linked to or otherwise associated with the intersected portions should be selected. For example, the horizontal bars of the word “I” may be indicated and the apostrophe of the word “don't” may be indicated even though those portions are not intersected.

The information or digital content to be selected may be identified by a freeform stroke or gesture other than a line intersecting the information or digital content. In various embodiments, the information or digital content to be selected may be at least partially enclosed by a freeform line that forms a substantially closed shape. For example, the information or digital content to be selected may be circled. Also, the information or digital content may be at least partially enclosed by a freeform line that substantially forms an oval, an ellipse or a polygon. The system according to various exemplary embodiments may differentiate between a line and a substantially closed shape based on the distance between the first and last positions of the freeform stroke or gesture.

The information or digital content to be selected may be identified by a pair of freeform strokes. The information or digital content that is at least partially disposed between the pair of freeform lines is identified. For example, the information or digital content to be selected may be identified as the information or digital content that is at least partially disposed between brackets, quotes, carats, substantially parallel lines or any other suitable pair of freeform lines.

Once the information or digital content is selected, the user may specify a location where the selected information or digital content is to be pasted. This may be accomplished by the user simply using a mouse click or a stylus touch. Alternatively, as shown in FIG. 3, this may be accomplished by the user by generating another freeform stroke or gesture, such as a line 524. The line 524 may be different than the line 538, for example, in orientation and/or length. The orientation and/or length of the line 524 may modify the orientation and/or size of the selected information or digital content or otherwise transform the selected information or digital content as desired by the user or a dictated by the attributes of the user note display 520. In other words, the freeform stroke or gesture used to specify the location for pasting may also indicate a modification or reformatting of the selected information or digital content. Alternatively, modification or reformatting of the selected information or digital content

Attributes of the display 520 may be defined by the display itself, for example, the size (available space) of the display and/or rules governing how information or digital content is displayed by the display. Selected content may be modified (e.g., scaled) to fit within the size of the display 520, reoriented (e.g., rotated) to account for the top/bottom of the display 520 and/or reformatted (e.g., font) to match a predetermined format or layout of the display 520.

Attributes of the display 520 may also be defined by the information or digital content that is already displayed in/on the display 520. For example, the existing information or digital content occupies a certain amount of the overall space available in/on the display 520 and occupies certain locations. Also, for example, the existing information or digital content may have a certain layout or format. The selected information or digital content may be transformed to fit within space in/on the display 520 that is not occupied by the existing information or digital content, to avoid hiding the existing information or digital content and/or to match the layout or format of the existing information or digital content. Additionally, the existing information or digital content may be transformed to accommodate the pasted information or digital content. For example, the existing information or digital content may be resealed or reformatted so that the existing information or digital content and the pasted information or digital content are satisfactorily displayed.

In general, the types of transformations that may be employed by the systems and methods according to this invention include, but are not limited to, resizing, rotating, translating, other linear or non-linear transformations. Further, the various types of translations may be applied to any segmented regions of an input and/or any output specified regions, for example, tessellations and other space-covering segmentations.

Once the location is determined, the selected information or digital content is pasted at the specified location, for example, in the user note display 520, as shown in FIG. 5. In this exemplary illustration, the selected information is rotated and scaled down.

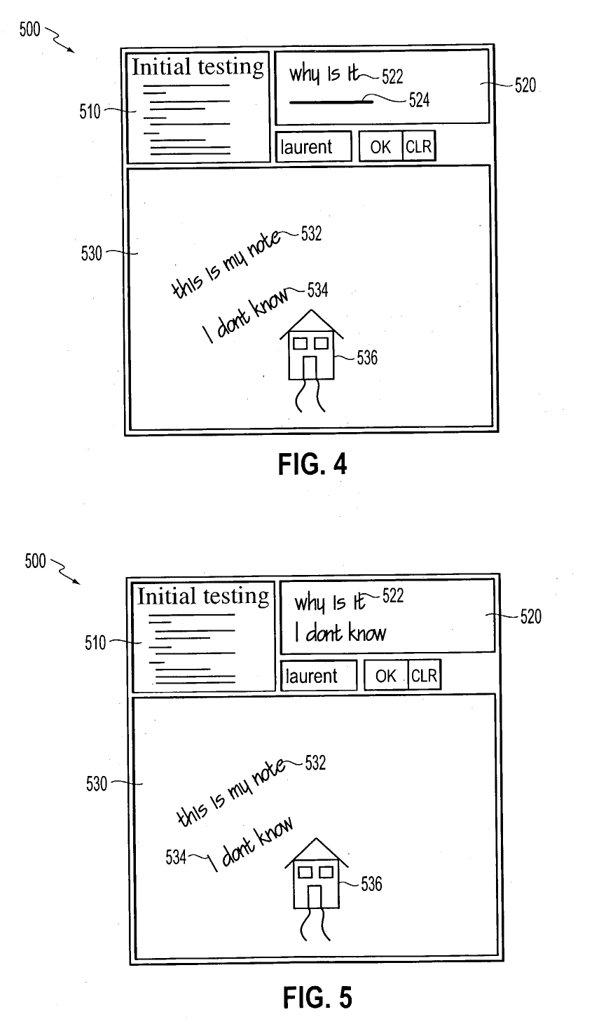

As shown in FIGS. 6-8, a user may select graphical content from a slide display to be pasted. FIG. 6 illustrates an original state of an exemplary display 600. The display 600 includes two areas: a slide display 610 showing a slide image of a current slide; and a user note display 620 showing one or more notes 522 of the user of the particular device. Although a shared note display is not illustrated, one may be included.

The user of the device may select information from the graphical content displayed by the slide display 610 using a freeform stroke or gesture. For example, as shown in FIG. 6, the user may generate a circle 612 that substantially encloses the graphical content “Increasing Awareness” to indicate that this graphical content is to be selected.

Once the graphical content is selected, the user may specify a location where the selected graphical content is to be pasted. This may be accomplished by the user simply using a mouse click or a stylus touch. Alternatively, as shown in FIG. 7, this may be accomplished by the user by generating another freeform stroke or gesture, such as a line 624. The line 624 is used to specify the location for pasting and may also indicate a modification or reformatting of the selected graphical content.

Once the location is determined, the selected graphical content is pasted at the specified location, for example, in the user note display 620, as shown in FIG. 8. In this exemplary illustration, the selected graphical content is wrapped around the freeform line 624.

As noted above, in various exemplary embodiments of the systems and methods according to this invention, the freeform pasting is shared. In various embodiments, users may be made aware of selections made by other users. For example, visual feedback such as a bounding box may identify the selections previously made by the user or other users. The visual feedback may also be provided by applying a visual modification to the selected content, such as, for example, highlighting, bolding, italicizing, changing color, and the like. In various embodiments, information regarding selections by individual users is reusable by the user or other users, for example, to facilitate selection of information or digital content, to determine the structure of the information or digital content, and/or to automatically segment information or digital content.

If a user has previously selected a portion of the selected graphical content such as “Awareness”, the system may identify this selection and allow the user or another user to select this graphical content, for example, using a single mouse click when using a mouse as an input device, or, for example, using a single tap when using a touch pad and stylus as an input device, such as with a PalmPilot® or other PDA. Thus, the subsequent selection does not require a complete freeform stroke or gesture.

Further, when the graphical content “Increased Awareness” is later selected, the system may automatically determine that “Awareness” may be a standalone object and may automatically segment the selected graphical content “Increased Awareness” into two parts.

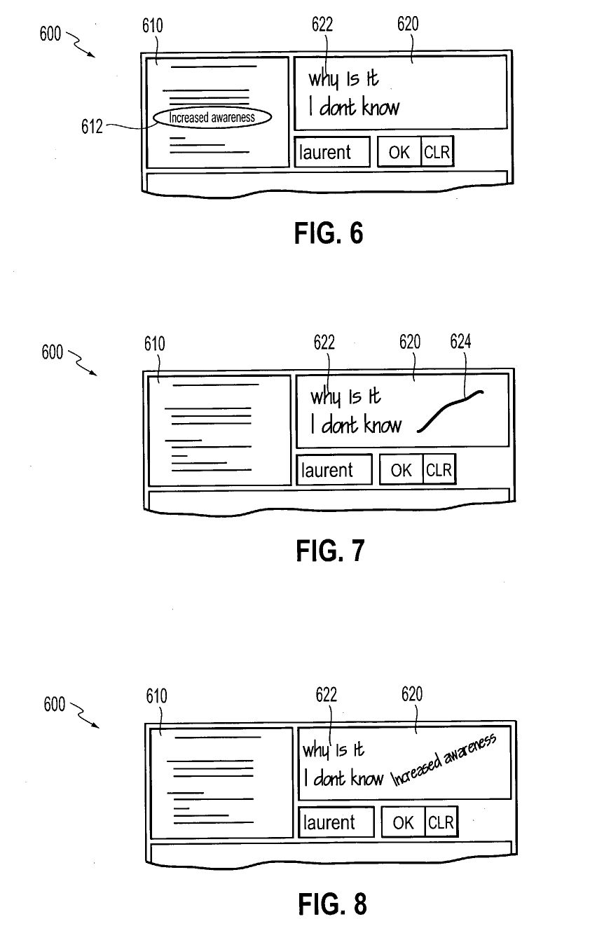

As illustrated in FIG. 9, a user may generate two separate freeform strokes or gestures, such as lines 724 and 726 to specify the location for the graphical content “Increased Awareness” to be pasted. The system is able to automatically segment the graphical content, based on the previous selection of “Awareness” as described above, and paste the two parts according to the two lines 724 and 726, as illustrated in FIG. 10.

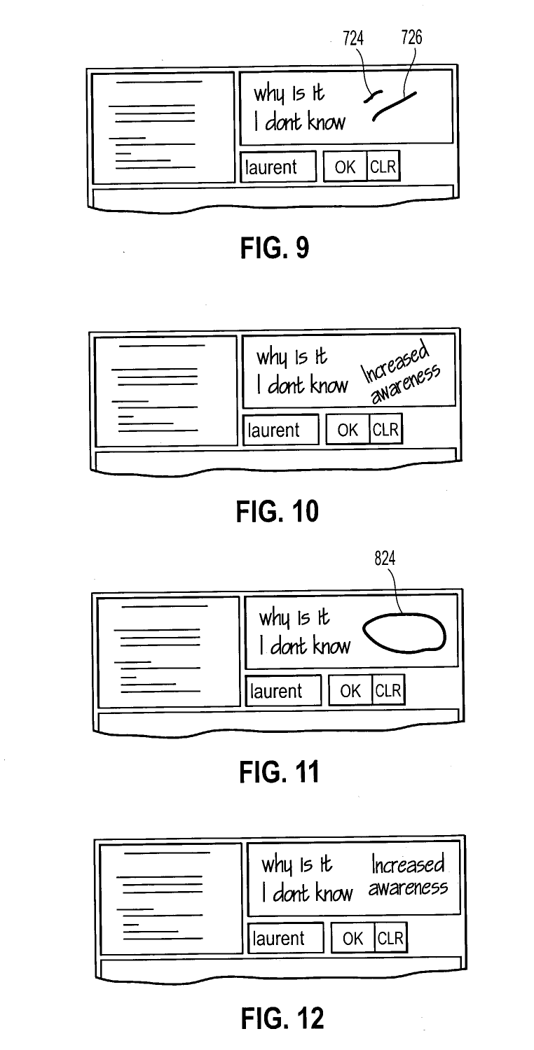

As illustrated in FIG. 11, a user may generate a single freeform stroke or gesture, such as an oval 824 to specify the location for the graphical content “Increased Awareness” to be pasted. Again, the system is able to automatically segment the graphical content, based on the previous selection of “Awareness” as described above, and paste the two parts according to the oval 824 by separating the two parts, as illustrated in FIG. 12. Without segmentation, the two parts of the graphical content “Increased Awareness” would be scaled down to fit within the oval 824 in line with each other.

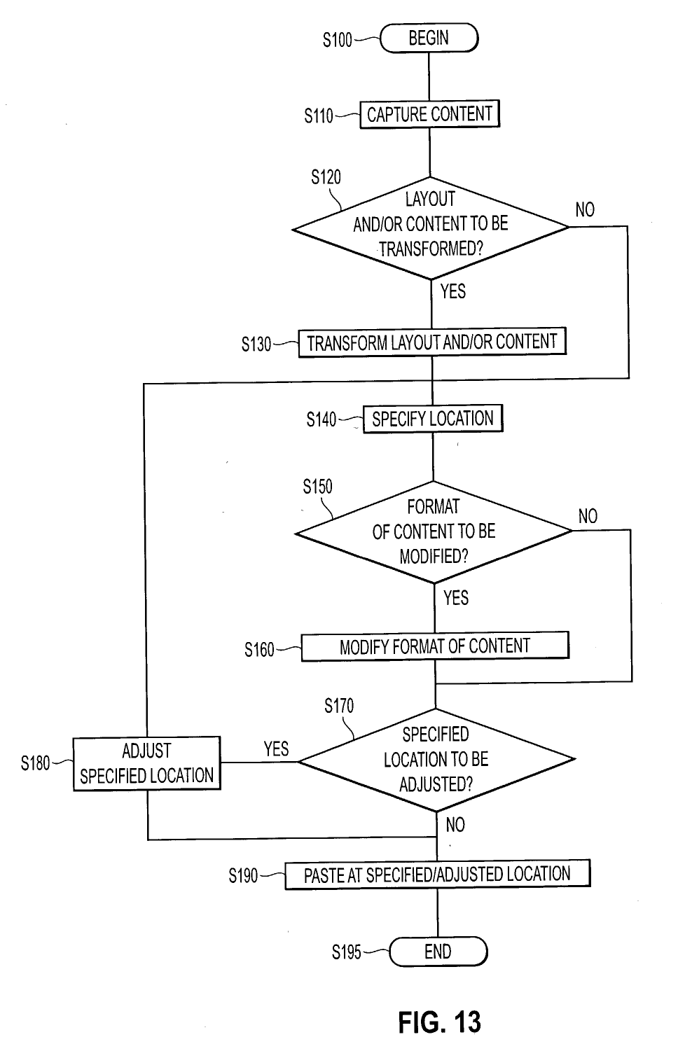

FIG. 13 is a flowchart outlining one exemplary embodiment of a method of freeform pasting according to this invention. Beginning in step S100, operation continues to step S110, where content is captured by a user. As described above, a user may identify content to be selected using a freeform stroke or gesture. Upon receiving the freeform stroke or gesture, the system selects the identified content. In various embodiments, metadata may be associated with the captured content. Such metadata may be, for example, freeform notes, textual notes, time/date information and/or source identification (e.g., url or filename from which the content is captured). Such metadata may be pasted along with the captured content and/or may be made available upon a user's request or action once the captured content has been pasted.

The capture of content may be accomplished in one or more modes. In a copy mode, a single content may be selected or captured at a time. The single captured content is “uncaptured” when another single content is selected or captured. This may be similar to the clipboard approach used in existing word processing software, where content is copied to a clipboard and stored there for pasting until replaced by other content or deleted.

In a sequencing mode, multiple contents may be selected or captured without “uncapturing” previously captured content. The captured content may be aggregated. A user may then chose to paste an aggregate of the contents. Further, each captured content may be queued in the order of capture. A user may then paste each content individually, one at a time.

In a segmentation mode, the captured content may be segmented. For example, a user may capture content of a screen region containing information such as a phone number, a url and a date. The information may be segmented into several parts, for example, corresponding to the phone number, the url and the date. This allows a user to select or capture the entire content at one time with a sequence of the parts automatically generated. A user may then paste the parts as an aggregate or paste the parts individually.

Next, in step S120, a determination is made whether or not the layout and/or content is to be transformed. In not, operation jumps to step S140. Otherwise, operation continues to step S130 where the layout and/or content is transformed. Step S130 may involve any known or later developed processing technique for text, graphics, freeform ink or other digital content. For example, optical character recognition (OCR) and image segmentation techniques may be used to extract information. Step S130 may be executed automatically by the system or may be controlled by user input.

Next, in step S140, a user specifies a location for the captured content to be pasted. As described above, a user may simply click or tap on a location or may generate a freeform input that identifies the location where the captured content is to be pasted. For example, a mouse or stylus may be used. A user may also specify the mode of pasting at this time, that is, whether to paste an aggregate or one content at a time as described above.

The freeform input may also be used to indicate how the captured content is to be pasted, as described above. For example, a closed line may be generated. The space defined by the closed line may then be used to control the format of the captured content that is later pasted.

Alternatively, one or more open lines or curves may be generated. The open lines or curves may not only define the location for pasting the captured content, but also may define the layout or formatting of the captured content that is to be pasted. For example, the captured content may be wrapped around or along the open lines or curves and/or may be segmented in accordance with multiple lines or curves.

Furthermore, in various embodiments, the layout or formatting of content pre-existing at or near the specified location for pasting the captured content may be altered. For example, pre-existing content may be moved apart to make room for the captured content to be pasted. Alternatively, the captured content to be pasted mat be reformatted based on the pre-existing content, for example, so as not to hide the pre-existing content upon pasting the capture content. The captured content to be pasted may also be altered to allow it to be pasted over and displayed on top of the pre-existing content without completely obscuring the pre-existing content.

In step S150, a determination is made whether or not the format of the captured content is to be modified. If not, operation jumps to step S170. Otherwise, operation continues to step S160, where the format of the captured content is modified. For example, the captured content may be reformatted to fit within an area defined by a freeform input, as described above, by segmentation and/or rescaling. Further, a user may rearrange the captured content manually prior to pasting, for example, by using a preview display. Such rearrangement may be made available as a defined action for modifying subsequently captured content, for example, to obtain a uniform format or layout of similar or related captured and pasted content. The defined action may be implemented automatically based on attributes of the captured content or upon a user request or action.

In step S170, a determination is made whether or not the location specified in step S140 is to be adjusted. If not, operation jumps to step S190, where the selected content is pasted at the specified location. Operation then continues to step S195 where the process ends. Otherwise, operation continues to step S180, where the specified location is adjusted. The adjustment may be performed automatically by the system, for example, based on the layout or format previously determined. Alternatively, a user may change the specified location manually. If the adjustment is made by the user, then operation returns to step S140. Otherwise, operation continues to step S190 where the selected content is pasted at the adjusted location. Operation then continues to step S195 where the process ends.

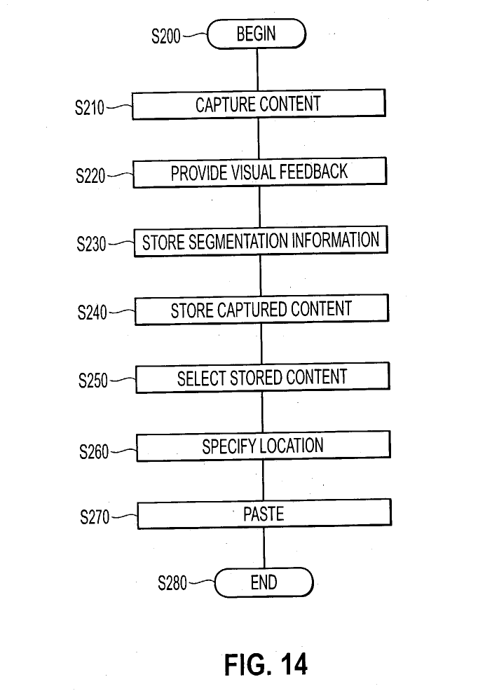

FIG. 14 is a flowchart outlining one exemplary embodiment of a method of shared freeform pasting according to this invention. Beginning in step S200, operation continues to step S210, where content is captured by a user. As described above, the user identifies the content to be selected using a freeform stroke or gesture. Upon receiving the freeform stroke or gesture, the system selects the identified content.

After the content is selected, the selected content is identified. Thus, operation continues to step S220, where visual feedback is provided. As described above, any suitable visual feedback may be provided. The visual feedback lets the user and any other users know that the selected content has been selected. This facilitates later selection of the same content by the same user or other users.

Operation continues to step S230, where information regarding segmentation of the selected content is stored. The stored segmentation information allows the system to automatically segment the selected content when the same content is later selected by the user or other users.

Operation continues to step S240, where the selected content is stored. Because the selected content is stored, the user or other users may reselect that content in a simplified manner. In other words, a single click, tap or touch may be used to select content that has previously been selected, rather than the freeform user input that was initially used to select that content. Thus, in step S250, the stored content is selected.

Next, in step S260, a user specifies a location for the selected stored content to be pasted. As described above, a user may simply click or tap on a location. Then, in step S270, the selected stored content is pasted at the specified location. Operation continues to step S280, where operation of the process ends.

It should be understood that various features of the exemplary embodiment of a method of freeform pasting described above may be incorporated into the method of shared freeform pasting. Such details are not shown in the exemplary embodiment illustrated in FIG. 14 only for the sake of clarity and simplicity.

While this invention has been described in conjunction with various exemplary embodiments, it is to be understood that many alternatives, modifications and variations would be apparent to those skilled in the art. Accordingly, Applicants' intent to appraise all such alternatives, modifications, and variations that follow in the spirit and scope of this invention. In particular, while the exemplary embodiments described above involve a system and method for collaborative note taking, it is to be understood that the system and methods of this invention may be used with any suitable display system.

What is claimed is:

1. A method of freeform pasting, comprising:
selecting at least one displayed content indicated by a user input;
determining a location specified by a freeform user input; and
pasting the selected content at the specified location in accordance with the freeform user input.

2. The method of claim 1, wherein selecting at least one displayed content comprises identifying the at least one displayed content intersected by a freeform line.

3. The method of claim 1, wherein selecting at least one displayed content comprises identifying the at least one displayed content at least partially enclosed by a freeform line that forms a substantially closed shape.

4. The method of claim 3, wherein selecting at least one displayed content comprises identifying the at least one displayed content at least partially enclosed by a freeform line that substantially forms at least one of a circle, an oval, an ellipse and a polygon.

5. The method of claim 1, wherein selecting at least one displayed content comprises identifying the at least one displayed content at least partially disposed between a pair of freeform lines.

6. The method of claim 5, wherein selecting at least one displayed content comprises identifying the at least one displayed content at least partially disposed between at least one of brackets, quotes, carats and substantially parallel lines.

7. The method of claim 1, wherein selecting at least one displayed content comprises selecting at least one freeform ink.

8. The method of claim 1, wherein pasting the selected content at the specified location in accordance with the freeform user input comprises transforming the selected content.

9. The method of claim 8, wherein transforming the selected content comprises wrapping the selected content around a freeform line corresponding to the freeform user input.

10. The method of claim 8, wherein transforming the selected content comprises fitting the selected content into an area defined by a freeform line corresponding to the freeform user input.

11. The method of claim 10, wherein fitting the selected content into an area defined by the freeform line comprises at least one of scaling, reorienting and segmenting the selected content.

12. The method of claim 1, wherein pasting the selected content at the specified location in accordance with the freeform user input comprises transforming existing content.

13. A method of freeform pasting, comprising:
selecting at least one displayed content indicated by a freeform user input;
identifying the selected content based on the freeform user input;
selecting the identified content;
determining a location specified by a user; and
pasting the selected identified content at the specified location.

14. The method of claim 13, wherein identifying the selected content based on the freeform user input comprises storing the selected content.

15. The method of claim 14, wherein identifying the selected content based on the freeform user input further comprises storing segmentation information for the selected content.

16. The method of claim 13, wherein identifying the selected content based on the freeform user input comprises providing visual feedback to a user.

17. The method of claim 16, wherein providing visual feedback to a user comprises applying a visual modification to the selected content.

18. The method of claim 13, wherein selecting the identified content comprises one of touching, tapping and clicking the identified content.

19. The method of claim 13, wherein determining a location specified by a user comprises determining a location specified by a freeform user input; and
wherein pasting the selected identified content at the specified location comprises pasting the selected content at the specified location in accordance with the freeform user input.

20. A system for freeform pasting, comprising:
a display that displays at least one content;
a user input that selects a displayed content;
a user input that determines a location by a freeform user input; and
a controller that pastes the selected content at the determined location in accordance with the freeform user input.

21. A system for freeform pasting, comprising:
a display that displays at least one content;
a user input that selects and identifies a displayed content by a freeform user input;
a user input that selects the identified content;
a user input that determines a location; and
a controller that pastes the selected content at the determined location.
